(19) United States
(12) Patent Application Publication
(10) Pub. No.: US 2009/0237429 A1
(43) Pub. Date: Sep. 24, 2009

(54) Print data generating apparatus, method to generate print data, and computer usable medium therefor

(75) Inventor: Takeshi Watanabe, Nagoya (JP)

Correspondence Address: OLIFF & BERRIDGE, PLC, P.O. BOX 320850, ALEXANDRIA, VA, 22320-4850, US

(73) Assignee: BROTHER KOGYO KABUSHIKI KAISHA, Nagoya (JP)

(21) Appl. No.: 12/382,456

(22) Filed: Mar. 17, 2009

(30) Foreign Application Priority Data
Mar. 20, 2008 (JP) 2008-072619

(51) Int. Cl. B41J 29/38

(52) U.S. Cl. 347/9

(57) ABSTRACT

A print data generating apparatus to generate print data to be used in a printing apparatus which is capable of ejecting ink drops in a specific color on one spot to form a pixel, including, a plurality of inkjet heads, each of which has nozzles aligned in line, a usable nozzle number determining unit to determine a number of at least one usable nozzle to be used, a count storing unit to store a count of ejecting operations of each nozzle to be performed, a usable nozzle extracting unit to extract the at least one usable nozzle among the grouped nozzles, and a print data generating unit to generate the print data, which controls the at least one usable nozzle to eject the ink. The usable nozzle extracting unit extracts at least one nozzle with a lower count of ejecting operations preferentially to be the at least one usable nozzle.

### CROSS REFERENCE TO RELATED APPLICATION

This application claims priority from Japanese Patent Application No. 2008-072619, filed on Mar. 20, 2008, the entire subject matter of which is incorporated herein by reference.

### BACKGROUND

1. Technical Field

Aspects of the present invention relate to a print data generating apparatus, a method to generate print data, and a computer usable medium therefor, and more specifically, to an apparatus, a method, and a computer usable medium to generate print data which is suitable for printing an image with a plurality of inkjet heads.

2. Related Art

Conventionally, an inkjet printing apparatus, which ejects a plurality of colors of inks onto a recording medium, has been known In the inkjet printing apparatus, the inks are drawn from ink reservoirs to a plurality of ejecting channels provided in an inkjet head and ejected from nozzles at the end of the ejecting channels when actuators such as heater elements and piezoelectric elements are selectively activated. When an image is formed in colors, each of pixels composing the image is resolved, for example, into the three primary colors, which are cyan (C), magenta (M), and yellow (Y), thereafter, a colored pixel is formed as the inks adjusted in their densities are ejected onto the recording medium. In addition, opaque white (W) ink can be used to reproduce white pixels and to form a base layer on a dark-colored (i.e., black) recording medium so that pixels in the three primary colors (transparent) can be reproduced clearly over the base layer regardless of a color of the recording medium. Thus, images reproduced in higher quality can be obtained without being limited by colors and lightness of the recording media.

In order to shorten operation time for printing an image, an inkjet printer having a plurality of inkjet heads to eject inks in a same color is suggested in, for example, Japanese Patent Provisional Publication No. HEI8-2005. Specifically, when the white ink is placed in a plurality of layers in order to assure whiteness, a plurality of inkjet heads can be used to efficiently eject the same white ink. Further, an inkjet printer disclosed in Japanese Patent Provisional Publication No. HEI3-158247, for example, is configured to avoid ejecting ink drops on a same spot so that the ejected ink drops are prevented from growing to be particles on a recording medium, and the image can be reproduced in desirable gradation.

### SUMMARY

In the conventional printing apparatuses with a plurality of inkjet heads, however, when some or the inkjet heads are used more frequently than the others, inks in nozzles of the unused inkjet heads may become dry and coagulated, and the nozzles may not function properly.

In view of the above drawbacks, the present invention is advantageous in that a print data generating apparatus, a method to generate print data, and a computer usable medium therefor, by which print data to use the plurality of nozzles of inkjet heads evenly to maintain a quality of the image can be generated, are provided.

According to an aspect of the invention, a print data generating apparatus is provided. The print data generating apparatus generates print data, which is to be used in a printing apparatus, capable of ejecting a plurality of ink drops of ink in a same specific color on a same spot to form a pixel, to print an image based on originally inputted image data representing the image. The print data generating apparatus includes a plurality of inkjet heads, each of which is provided with a plurality of nozzles aligned in line to eject the ink, a usable nozzle number determining unit to determine a number of at least one usable nozzle to be used to form the pixel among a group of nozzles, which are provided to corresponding positions in the respective inkjet heads and potentially capable of ejecting the ink on the same spot, for each pixel included in the image data, a count storing unit to store a count of ejecting operations of each nozzle to be performed for printing the image, a usable nozzle extracting unit to extract the at least one usable nozzle among the grouped nozzles based on the counts of ejecting operations of each nozzle stored in the count storing unit, and a print data generating unit to generate the print data, which controls the at least one usable nozzle, extracted by the usable nozzle extracting unit, to eject the ink to form the pixel. The usable nozzle extracting unit extracts at least one nozzle with a lower count of ejecting operations preferentially to be the at least one usable nozzle among the grouped nozzles based on the number determined by the usable nozzle number determining unit.

According to another aspect of the invention, a method to generate print data to control a printing apparatus, which is capable of ejecting a plurality of ink drops of ink in a same specific color on a same spot to form a pixel and having a plurality of inkjet heads, each of which is provided with a plurality of nozzles aligned in line to eject the ink, based on originally inputted image data representing the image, is provided. The method includes steps of determining a number of at least one usable nozzle to be used to form the pixel among a group of nozzles, which are provided to corresponding positions in the respective inkjet heads and potentially capable of ejecting the ink on the same spot, for each pixel included in the image data, storing a count of ejecting operations of each nozzle to be performed for printing the image, extracting the at least one usable nozzle among the grouped nozzles based on the counts of ejecting operations of each nozzle stored in the count storing unit, and generating the print data, which controls the at least one usable nozzle, extracted by the usable nozzle extracting unit, to eject the ink to form the pixel. At least one nozzle with a lower count of ejecting operations is extracted preferentially to be the at least one usable nozzle among the grouped nozzles in the step of extracting based on the number determined in the step of determining.

According to still another aspect of the invention, a computer usable medium to include computer readable instructions to control a computer to generate print data is provided. The print data is to be used in a printing apparatus capable of ejecting a plurality of ink drops of ink in a same specific color on a same spot to form a pixel and having a plurality of inkjet heads, each of which is provided with a plurality of nozzles aligned in line to eject the ink, based on originally inputted image data representing the image. The computer readable instructions controls the computer by executing steps of determining a number of at least one usable nozzle to be used to form the pixel among a group of nozzles, which are provided to corresponding positions in the respective inkjet heads and potentially capable of ejecting the ink on the same spot, for each pixel included in the image data, storing a count of ejecting operations of each nozzle to be performed for printing the image, extracting the at least one usable nozzle among the grouped nozzles based on the counts of ejecting operations of each nozzle stored in the count storing unit, and generating the print data, which controls the at least one usable nozzle, extracted by the usable nozzle extracting unit, to eject the ink to form the pixel. At least one nozzle with a lower count of ejecting operations is extracted preferentially to be the at least one usable nozzle among the grouped nozzles in the step of extracting based on the number determined in the step of determining.

### BRIEF DESCRIPTION OF THE ACCOMPANYING DRAWINGS

FIG. 1 is a plane view of an inkjet printer according to an embodiment of the present invention.

FIG. 2 is a block diagram to illustrate an electrical configuration of the inkjet printer according to the embodiment of the present invention.

FIG. 3 is a block diagram to illustrate an electrical configuration of a PC (personal computer) according to the embodiment of the present invention.

FIG. 4 is a schematic diagram of a RAM (random access memory) in the PC according to the embodiment of the invention.

FIG. 5 is a schematic diagram of an HDD (hard disk drive) in the PC according to the embodiment of the invention.

FIG. 6 illustrates transition of data in a print data generating process according to the embodiment of the invention.

FIG. 7 illustrates a data configuration of a color conversion table according to the embodiment of the present invention.

FIG. 8 illustrates a data configuration of a white conversion table according to the embodiment of the present invention.

FIG. 9 is a table defining correspondences between random-dithered results of W-scale values converted from 256-scaled values into quinary-formatted values and a number of nozzles to eject white ink according to the embodiment of the present invention.

FIG. 10 is a flowchart to illustrate a print data generating process to be executed in the PC according to the embodiment of the present invention.

FIG. 11 is a flowchart to illustrate a W data calculating process to be executed in the print data generating process according to the embodiment of the present invention.

FIG. 12 is a flowchart to illustrate an usable nozzle extracting process to be executed in the W data calculating process according to the embodiment of the present invention.

FIG. 13 is a flowchart to illustrate a three-nozzles extracting process to be executed in the usable nozzle extracting process according to the embodiment of the present invention.

FIG. 14 is a flowchart to illustrate a two-nozzles extracting process to be executed in the usable nozzle extracting process according to the embodiment of the present invention.

FIG. 15 is a flowchart to illustrate a one-nozzle extracting process to be executed in the usable nozzle extracting process according to the embodiment of the present invention.

### DETAILED DESCRIPTION

Hereinafter, embodiments according to aspects of the present invention will be described with reference to the accompanying drawings.

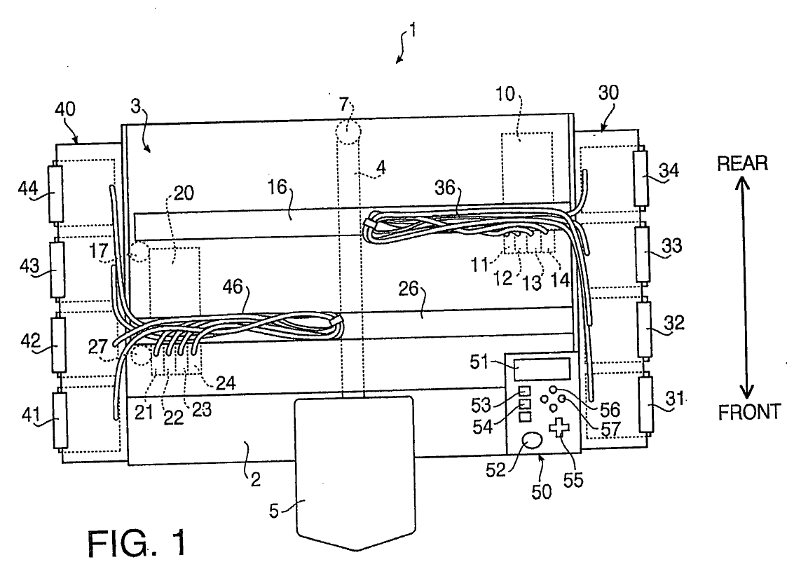

An inkjet printer 1 according to an embodiment of the present invention will be described with reference to FIG. 1. The inkjet printer 1 is a printing apparatus, which is capable of printing an image on a piece of fabric. FIG. 1 is a plane view of the inkjet printer 1 according to the first embodiment of the present invention.

As shown in FIG. 1, the inkjet printer 1 includes a flat base plate 2 at a bottom and a box-shaped cover 3 to cover the entire body of the inkjet printer 1. The base plate 2 has longer sides which extend in a right-and-left (horizontal) direction in FIG. 1, and a rail 4 is aligned in parallel with a front-rear direction at an approximate center of the base plate 2. The rail 4 supports a platen 5, which is interchangeable and movable in the front-rear direction (i.e., an auxiliary direction) along the rail 4. The platen 5 is carried along the rail 4 by a platen drive motor 7 being a stepping motor, which is provided at a rear end portion of the rail 4. The platen 5 is a substantially rectangular-shaped plate, on which a recording medium (e.g., a T-shirt) is placed.

At an approximately center but a relatively rear (i.e., closer to an upper side in FIG. 1) of the cover 3, above the platen 5, a first guide rail 16 to guide a first carriage 10 with four inkjet heads 11-14 mounted thereon is provided. In the vicinity of a left-hand end of the first guide rail 16, a first carriage motor 17 to drive the carriage 10 is provided, while a pulley (not shown) is provided in the vicinity of a right-hand end of the first guide rail 16. Further, a carriage belt (not shown) is drawn between the first carriage motor 17 and the pulley under the first guide rail 16. The carriage belt is fixed to the first carriage 10 so that the first carriage 10 is reciprocated along the first guide rail 16 in the right-and-left direction (i.e., a main scanning direction) when the carriage motor 17 is activated.

On the right-hand end of the cover 3, a first ink cartridge storage 30, in which four ink cartridges 31-34 having inks therein are detachably attached, is provided. Each of the ink cartridges 31-34 is connected to each of inkjet heads 11-14 by flexible ink supplying tubes 36 so that the inks stored in the ink cartridges 31-34 are supplied to each channel of the inkjet heads 11-14. According to the present embodiment, all of the inkjet heads 11-14 are provided to eject opaque white ink therefrom, and the ink cartridges 31-34 respectively contain opaque white ink.

At an approximately center but a relatively front (i.e., closer to a lower side in FIG. 1) portion of the cover 3, above the platen 5, a second guide rail 26, in parallel with the first guide rail 16, to guide a second carriage 20 with four inkjet heads 21-24 mounted thereon is provided. Further, a carriage belt (not shown) is drawn between the second carriage motor 27 and a pulley (not shown) under the second guide rail 26. The carriage belt is fixed to the second carriage 20 so that the second carriage 20 is reciprocated along the second guide rail 26 in the right-and-left direction (i.e., the main scanning direction) when the carriage motor 27 is activated.

In a left-end portion of the cover 3, a second ink cartridge storage 40, in which four ink cartridges 41-44 are stored, is provided. The ink cartridges 41-44 are respectively connected to the inkjet head 21-24 through ink supplying tubes 46 so that the inks in the ink cartridges 41-44 are supplied to each channel of the inkjet heads 21-24. The four ink cartridges 41-44 contain cyan (C) ink, magenta (M) ink, yellow (Y) ink, and black (K) ink respectively.

At right-hand front of the inkjet printer 1 is provided an operation panel 50 to which a user inputs an instruction for the inkjet printer 1. The operation panel 50 includes a display 51, a print start button 52, a print cancel button 53, and a platen feed button 54, a direction key 55, an error indicator 56, and a data reception indicator 57. The display 51 is to display various information concerning, for example, operations in the inkjet printer 1. The print start button 52 is a button to be operated when a print operation is started The cancel button 53 is a button to be operated when the print operation is ceased. When the platen feed button 54 is operated, the platen 5 is moved to a position wherein the fabric such as a T-shirt as the recording medium can be set on and removed from the platen 5. The direction key 55 is operated when, for example, the user selects an option concerning operations to be executed. The error indicator 56 is a lamp to be lit when an error occurs in the inkjet printer 1. The data reception indicator 57 is a lamp to be lit when print data is received in the inkjet printer 1.

The inkjet heads 11-14 and 21-24 will be described. Each of the inkjet heads 11-14 and 21-24 is provided with finely-formed 128 nozzles (not shown), which are aligned in line and equally spaced from one another, at a bottom thereof. The nozzles are aligned to be parallel with the auxiliary direction (i.e., the front-rear direction of the inkjet printer 1) of the inkjet heads 11-14, 21-24. According to the present embodiment, a length between adjoining nozzles in each inkjet head is 1/150 inch. The nozzles in each inkjet head are sequentially numbered from 1 to 128, and a nozzle number of a nozzle at a rear end is #128 while a nozzle number of a nozzle at a front end is #1.

The inkjet heads 11-14 and 21-24 are mounted on the carriages 10 and 20 respectively with the nozzle alignments to be parallel with one another. When a pixel is formed in color, using inks to be ejected from a plurality of inkjet heads, nozzles in the respective inkjet heads with an identical nozzle number are activated to eject the inks therefrom. For example, when a pixel with a Y value being 1 in a Y-coordinate, which is in parallel with the auxiliary direction of the inkjet heads 11-14, 21-24, is formed in a white color, the white ink can be ejected from a nozzle #1 in the inkjet head 11, a nozzle #1 in the inkjet head 12, a nozzle #1 in the inkjet head 13, and a nozzle #1 in the inkjet head 14 respectively. Further, when the pixel is formed in CMYK colors, the C, M, Y, K inks can be ejected from a nozzle #1 in the inkjet head 21, a nozzle #1 in the inkjet head 22, a nozzle #1 in the inkjet head 23, and a nozzle #1 in the inkjet head 24 respectively.

Each of the inkjet heads 11-14 for white ink in the first carriage 10 and the inkjet heads 21-24 for colored inks in the second carriage 20 is provided with a plurality of (for example, 128) ejection cannels (not shown) through which the ink is conveyed. Each of the channels is provided with a piezoelectric actuator (not shown), which is activated individually, to eject an ink drop downward onto the recording medium from ejection nozzles (not shown) that are open at a nozzle surface of each of the inkjet heads 11-14, 21-24. Further, at one of the right-hand end and the left-hand end of the reciprocative range of each of the first and second carriages 10, 20, a maintenance mechanism (not shown) such as a capping unit and a purge unit for the inkjet heads 11-14, 21-24 is provided.

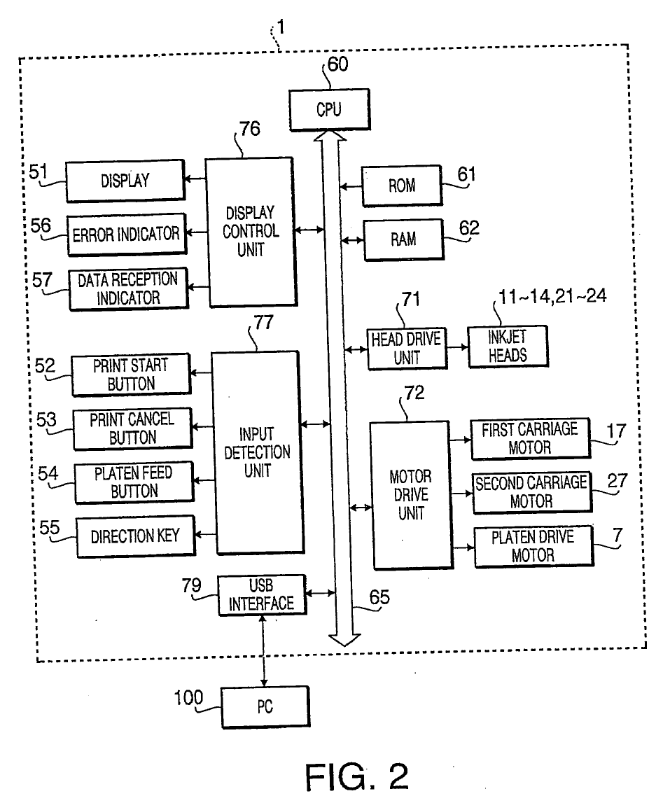

Next, referring to FIG. 2, an electrical configuration of the inkjet printer 1 will be described FIG. 2 is a block diagram showing the electrical configuration of the inkjet printer 1 according to the present embodiment of the invention. As shown in FIG. 2, the inkjet printer 1 is provided with a CPU 60 that controls the entire operation in the inkjet printer 1. The CPU 60 is connected with a ROM 61, a RAM 62, a head drive unit 71, a motor drive unit 72, a display control unit 76, an input detection unit 77, and a USB interface 79. These components are connected to one another through a bus 65.

The ROM 61 includes a program storage area, wherein control programs to be executed by the CPU 60 to control operations of the inkjet printer 1 and printing programs to be executed for the printing operations are stored, and a program-related information storage area, wherein various information such as parameter settings, initial values, and data to be used in the programs are stored. Further, the ROM 61 may include various storage areas.

The RAM 62 in the inkjet printer 1 is provided with several areas including a received print data storing area for storing the print data transmitted from a PC 100, an in-printing data storing area for storing the print data being printed, and various information storing areas for storing various setting information.

The head drive unit 71 is connected to each of the inkjet heads 11-14, 21-24 and activates the piezoelectric actuators being provided to each channel of the inkjet heads 11-14, 21-24.

The motor drive unit 72 is connected to the first carriage motor 17, the second carriage motor 27, and the platen drive motor 7. Thus, the first and the second carriage motors 17, 27, and the platen drive motor 7 are controlled by the motor drive unit 72.

The display control unit 76 executes displaying processes of the display 51, the error indicator 56, and the data reception indicator 57, which are connected to the CPU 60 through the bus 65. The input detection unit 77 detects inputs through the print start button 52, the print cancel button 53, the platen feed button 54, and the direction key 55, which are connected to the CPU 60 through the bus 65. The USB interface 79 which allows communication between the inkjet printer 1 and external devices including the PC 100 through a USB cable (not shown).

With the aforementioned configuration of the inkjet printer 1 according to the embodiment, when the print data transmitted from the PC 100 is received in the inkjet printer 1, the user sets a piece of fabric on the platen 5 and presses the print button 52. Accordingly, the platen 5 with the fabric is moved to rearward in the cover 3 of the inkjet printer 1 along the rail 4 by the platen drive motor 7 so that the position of the first carriage 10 with respect to the platen 5 corresponds to a recording start position. Thereafter, the inkjet heads 11-14 eject the white ink as the first carriage 10 is moved from the right-hand side to the left-hand side in the cover 3 according to a recording instruction so that recording of one line is executed. In this regard, the print data includes eight pieces of data, which are respectively C, M, Y, K, W1, W2, W3, and W4. The inkjet heads 11, 12, 13, 14 correspond respectively to W1, W2, W3, W4, and ejection of inks from the inkjet heads 11, 12, 13, 14 is controlled in accordance with the corresponding pieces of data When printing the line in white ink is completed, the platen 5 is moved to frontward from the rearward in the cover 3 for the amount corresponding to another one line portion. By repeating this operation, printing in white ink is executed.

Thereafter, the inkjet printer 1 moves the platen 5 with the fabric to frontward so that the position of the second carriage 20 with respect to the platen 5 corresponds to the recording start position. The second carriage 20 is driven similarly to the first carriage 10 as described above so that the colored (CMYK) inks are ejected onto the fabric according to the CMYK data. At the end of the printing operation, the platen 5 is fed forth to a position wherein the fabric can be removed, thus the user removes the fabric which underwent the printing operation.

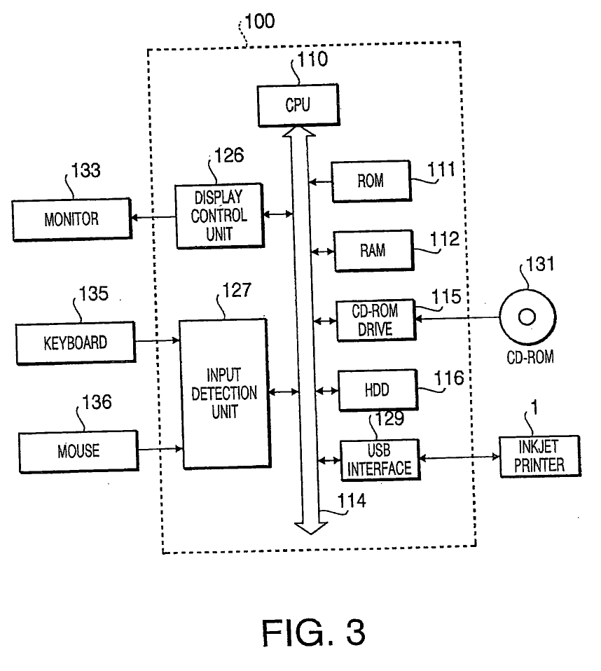

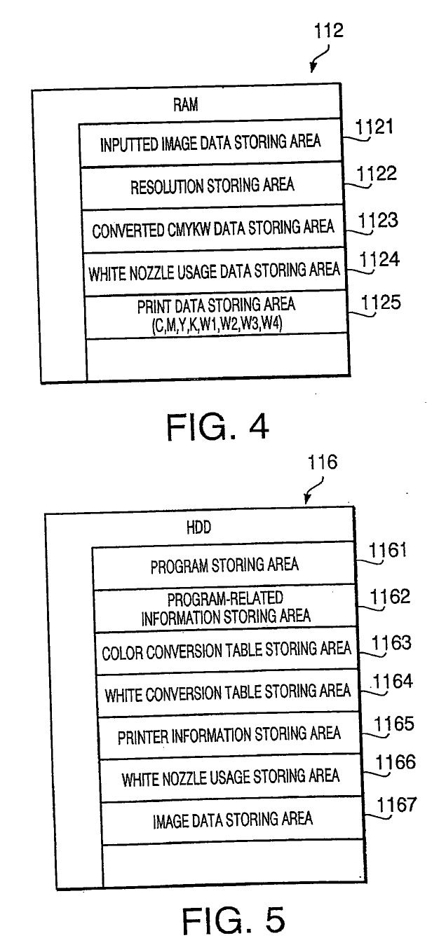

Next, a configuration of the PC 100 will be described with reference to FIGS. 3-5. FIG. 3 is a block diagram of an electrical configuration of the PC 100 according to the present embodiment of the invention. FIG. 4 is a schematic diagram of a RAM 112 in the PC 100 according to the present embodiment of the invention. FIG. 5 is a schematic diagram of an HDD 116 in the PC 100 according to the present embodiment of the invention. The PC 100 is connected to the inkjet printer 1 through a standardized communication cable, which is for example a USB. In the PC 100, print data is generated based on image data created by the user using various applications, and the print data is transmitted to the inkjet printer 1.

As shown in FIG. 3, the PC 100 is provided with a CPU 110 which controls the entire operation in the PC 100. The CPU 110 is connected with a ROM 111, a RAM 112, a CD-ROM drive 115, an HDD 116, a display control unit 126, an input detection unit 127, and a USB interface 129. These components are connected to one another through a bus 114.

The ROM 111 stores various information to be used in controlling programs, such as BIOS, to be executed by the CPU 110. The CD-ROM drive 115 is for reading data from a CD-ROM 131 inserted therein as a storage medium of data. The CD-ROM 131 stores data including a printer driver, which is a program to create the print data, and various settings, tables, and data to be used in the program. The data in the CD-ROM 131 is read by the CD-ROM drive 115 and stored in predetermined areas (see FIG. 5) in the HDD 116.

The display control unit 126 controls displaying processes to display information concerning an operation on a screen of a monitor 133. The input detection unit 127 is connected to input devices including a keyboard 135 and a mouse 136, which are operated by the user, and operations by the user to the input devices are detected by the input detection unit 127. The USB interface 129 allows communication between the PC 100 and external devices including the inkjet printer 1 through a USB cable (not shown).

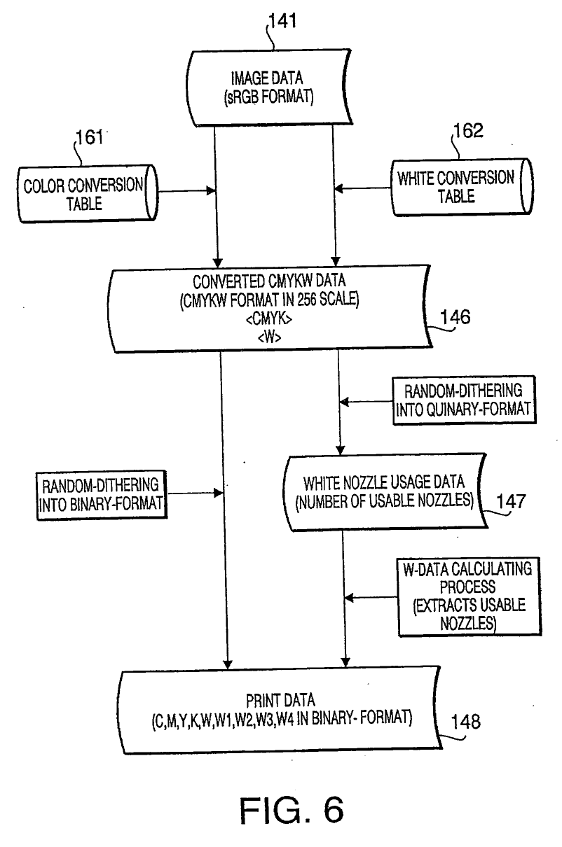

As shown in FIG. 4, the RAM 112 is provided with several storage areas including an inputted image data storing area 1121, a resolution storing area 1122, a converted CMYKW data storing area 1123, a white nozzle usage storing area 1124, and a print data storing area 1125. The inputted image data storing area 1121 is a storage area for temporarily storing inputted image data 141 (see FIG. 6). The print data for printing an image is created based on the originally inputted image data being stored in the inputted image data storing area 1121. The resolution storing area 1122 is a storage area for a resolution R specified by the user. The converted CMYKW data storing area 1123 is a storage area for storing converted CMYKW data 146 (see FIG. 6), which is converted from the inputted image data 141. The white nozzle usage storing area 1124 is a storage area for storing white nozzle usage data 147 (see FIG. 6). The white nozzle usage data 147 indicates a number of usable nozzles among four grouped nozzles in the inkjet heads 11-14 to be used to form a pixel in the white ink. Specifically, in the present embodiment, the grouped nozzles refer to potential nozzles in the inkjet heads 11-14 with an identical nozzle number potentially capable of ejecting the white ink on a same spot to form the pixel. The nozzles to be actually used to eject the white ink to form the pixel among the grouped nozzles will be referred to as usable nozzles. The print data storing area 1125 is a storage area for storing print data 148 (see FIG. 6), which is binary data indicating values of C, M, Y, K, W1, W2, W3, W4 to drive the inkjet heads 11-14, 21-24. Functions of the above-mentioned data will be described later in detail.

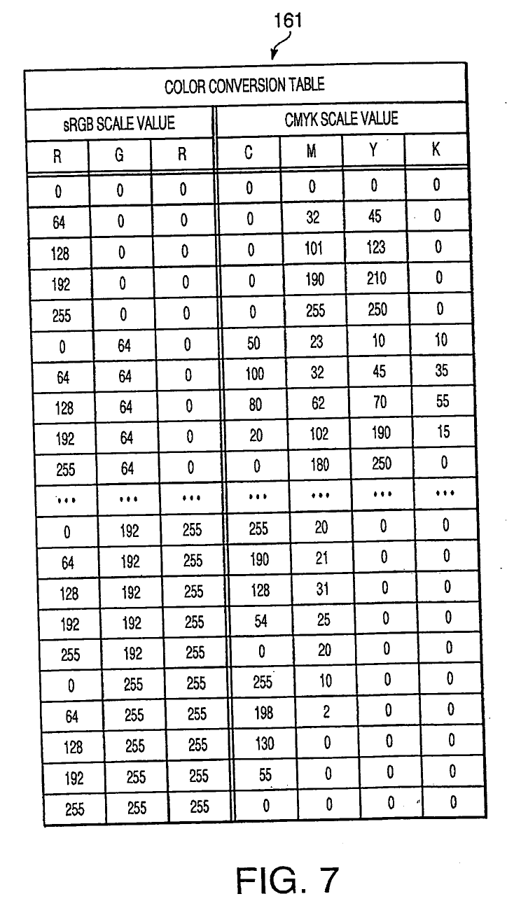

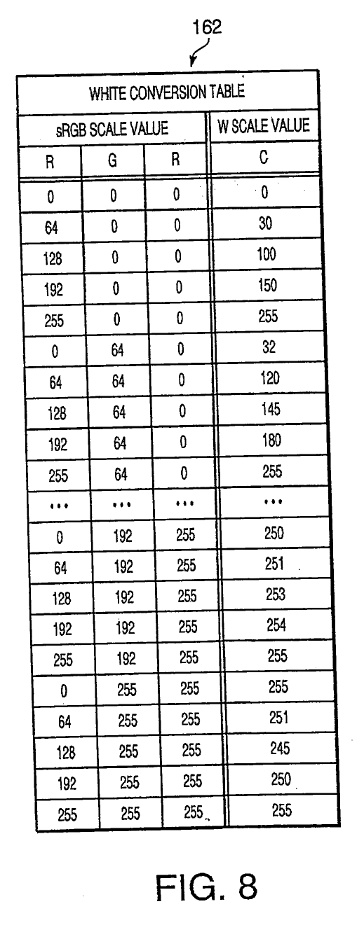

As shown in FIG. 5, the HDD 116 contains several storage areas including a program storing area 1161, a program-related information storing area 1162, a color conversion table storing area 1163, a white conversion table storing area 1164, a printer information storing area 1165, a white nozzle usage storing area 1166, and an image data storing area 1167. The program storing area 1161 is a storage area for storing various programs to be executed in the PC 100 including the printer driver. The program-related information storing area 1162 is a storage area for storing information concerning settings, initial values, and data necessary for executing the programs. The color conversion table storing area 1163 is a storage area for storing a color conversion table 161 (see FIG. 7). The color conversion table 161 defines correspondence between color information of the inputted image data 141, which is represented in sRGB format, and a colored ink level, which is represented in a CMYK format The color conversion table 161 is thus used for converting the inputted image data 141 into a colored ink level in CMYK format The white conversion table storing area 1164 is a storage area for storing a white conversion table 162 (see FIG. 8), which is for converting the inputted image data 141 into a white ink level (in a W format). The printer information storing area 1165 is a storage area for storing information concerning an inkjet printer, specifically a number n of nozzles aligned in line in an inkjet head and space L between the adjoining nozzles in the inkjet head. The white nozzle usage storing area 1166 is an area for storing a count of ejecting operations of the white ink for each of the nozzles in the inkjet heads 11-14. The image data storing area 1167 is a storage area for storing a plurality of pieces of image data 141. Functions of the above-mentioned data will be described later in detail.

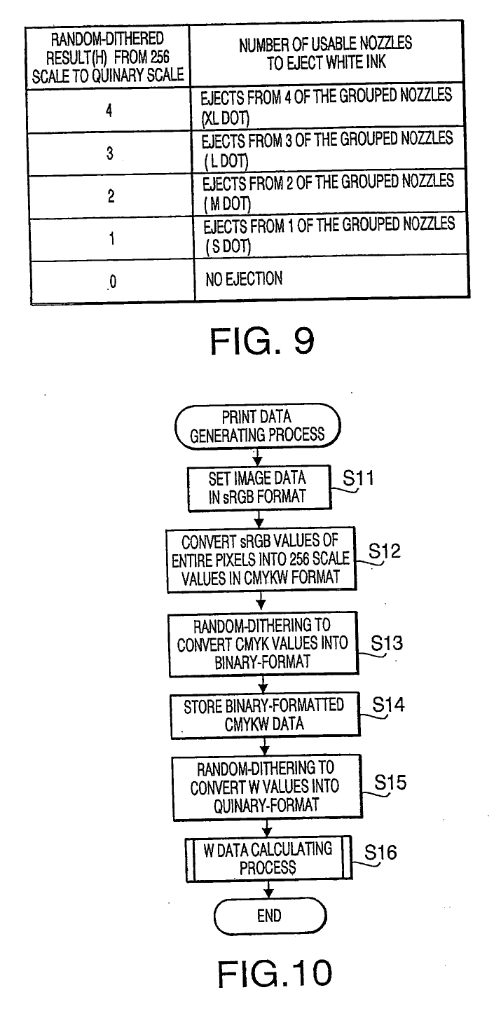

Hereinafter, with reference to FIGS. 6-9, the data to be generated in the print data generating process according to the present embodiment will be described. FIG. 6 illustrates transition of data in the print data generating process according to the embodiment of the invention. FIG. 7 illustrates a data configuration of the color conversion table 161 according to the embodiment of the present invention. FIG. 8 illustrates a data configuration of the white conversion table 162 according to the embodiment of the present invention. FIG. 9 is a table defining correspondences between random-dithered results of W-scale values converted from 256-scaled values into quinary-scaled values and a number of nozzles to eject white ink according to the embodiment of the present invention.

As shown in FIG. 6, the print data 148 is generated based on the image data 141 stored in the inputted image data storing area 1121 in the RAM 112. The image data 141 is the data specified to be printed by the user among a plurality of pieces of image data which have been created by the user using various applications such as an application designed for editing graphics. Thus, the image data 141 is saved in the image data storing area 1167 of the HDD 116. Specifically, the image data 141 according to the present embodiment is represented in 256 color scale of the image data in sRGB format. The sRGB is an international standard of color space established by the IEC (International Electrotechnical Commission), and various PC peripherals including digital cameras, printers, and monitors perform color adjustment according to the sRGB to minimize a color difference between the inputted color and output color.

When an image is printed in a printing apparatus such as the inkjet printer 1 by ejecting the inks, a color of each pixel composing the image, represented in the sRGB format, is converted into CMYKW format to be CMYKW data 146. The CMYKW format is a method to reproduce a color in cyan (C), magenta (M), yellow (Y), black (K), and white (W). A color of each pixel is defined by combination of the C-scale value, M-scale value, Y-scale value, K-scale value, and W-scale value, which are respectively defined in 256 color scales. The image data 141 is converted into the CMKYW data 146 based on the color conversion table 161 and the white conversion table 162.

The color conversion table 161 is a table for converting the input data in 256 color scale in the sRGB format into the output data in 256 color scale in the CMYK format. As shown in FIG. 7, each of the CMYK scale values is defined to correspond to an sRGB scale value respectively. The sRGB scale values of each pixel which composes the image data 141 are converted into the corresponding CMYK scale values respectively based on the color conversion table 161. Thus, the image data 141 is converted in the colored ink level data according to the color conversion table 161. The color conversion table 161 is created in a known method and stored preliminarily in the HDD 116.

Meanwhile, the white ink level data in W format is created in a process such that the sRGB scale values of each pixel which composes the image data 141 are converted into the W-scale values respectively based on the white conversion table 162 stored in the white conversion table storing area 1164 of the HDD 116. The white conversion table 162 is a table for converting the input data in 256 color scale in the sRGB format into the output data in 256 color scale in W format. As shown in FIG. 8, the W-scale value is defined to correspond to each of the sRGB scale values respectively. Further, the sRGB scale values of each pixel which composes the image data 141 are converted into the corresponding W-scale value respectively based on the white conversion table 162. Thus, the image data 141 is converted in the white ink level data according to the white conversion table 162. The converted CMYKW data 146 in 256 color scale is thus composed by the CMYK scale values in the colored ink level data and the W-scale values in the white ink level data.

The CMYK scale values in the converted CMYKW data 146 in 256 scales are processed to be binary data through a known random-dithering method (S13, FIG. 10) so that the print data 148, in which a color of each pixel therein is binary-formatted (i.e., indication as to whether each of the CMYK inks is ejected or not ejected), is created. The random-dithering is a known method to binary-formatted 256-scaled data.

According to the present embodiment, use of the white ink in addition to the CMYK inks enables to form an image with pixels in white on a recording medium with a relatively dark base color such as black. Further, with the white ink, a base layer in white can be formed, and colored pixels can be formed on the white base layer. Thus, images reproduced in higher quality can be obtained without being limited by colors and lightness of the recording media Moreover, a plurality of layers of white ink may be formed by the plurality of inkjet heads 11-14 in order to secure whiteness in a shorter period of time. Furthermore, the number of inkjet heads to eject the white ink may be changed so that a degree of whiteness can be modified.

Therefore, the W-scale values in the converted CMYKW data 146 in 256 scales are processed to be quinary data through a known random-dithering method (S15, FIG. 10) in order to obtain a number of nozzles among the grouped nozzles of the inkjet heads to be used to eject the white ink. In the random-dithering process, the W-scale values in 256 scales can be sorted into one of five scales (i.e., 0 through 4) defined by four thresholds. In the present embodiment, each of the five scales 0-4 corresponds to a number H of the usable nozzles for a pixel, and the numbers H for the pixels in the entire image are included to be a piece of white nozzle usage data 147 to be stored in the white nozzle usage storing area 1124.

When the number H obtained in the random-dithering process indicates 4 (see FIG. 9), all of the four nozzles in the four grouped nozzles in the inkjet heads 11-14 are used to eject the white ink therefrom. Consequently, four ink drops of the white ink are dropped on a same spot and form a largest (XL) white dot. When the number H obtained in the random-dithering process indicates 3, three nozzles among the four grouped nozzles are used to eject the white ink therefrom. Consequently, three ink drops are dropped on a same spot and form a large (L) dot. When the number H obtained in the random-dithering process indicates 2, two nozzles among the four grouped nozzles are used to eject the white ink therefrom. Consequently, two ink drops are dropped on a same spot and form a medium (M) dot. When the number H obtained in the random-dithering process indicates 1, one nozzle among the four grouped nozzles is used to eject the white ink therefrom. Consequently, one ink drop is dropped on a spot and form a small (S) dot. When the number H obtained in the random-dithering process indicates 0, no nozzle is used; therefore, no ink drop to form a dot is dropped.

Conventionally, however, when the number of the nozzles to be used is 1, 2, or 3 (i.e., at least one of the grouped nozzles remains unused), frequencies of the nozzles to be used may become uneven. For example, when the number H of the ejecting nozzles is 3, three grouped nozzles of the inkjet heads 11-13 are used, but one remaining grouped nozzle of the inkjet head 14 is not used. Thus, the usage frequency of the nozzles in the entire inkjet head 14 becomes low, and the ink at the less-used nozzles can be dried. When the ink is dried and coagulated at the nozzles, the nozzles may not function properly.

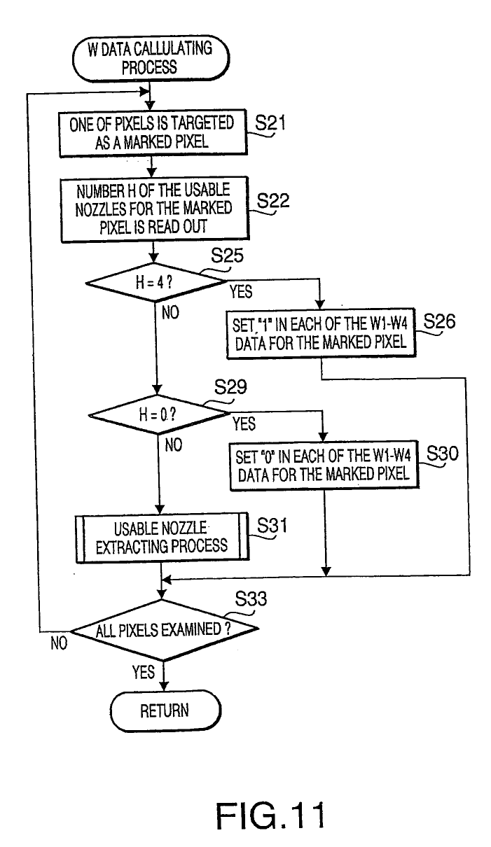

Therefore, in order to balance the usage of the grouped nozzles, the PC 100 according to the present embodiment generates W data indicating usage of the four grouped nozzles in a W data calculating process (FIGS. 11-15) based on the white nozzle usage data 147. More specifically, W1-W4 data in the print data 148 to control the inkjet heads 11-14 is generated so that a less-frequently used nozzle is preferentially used among the four grouped nozzles based on a number of times of each grouped nozzle being recorded.

Next, a print data generating process according to the present embodiment will be described with reference to FIGS. 10-15.

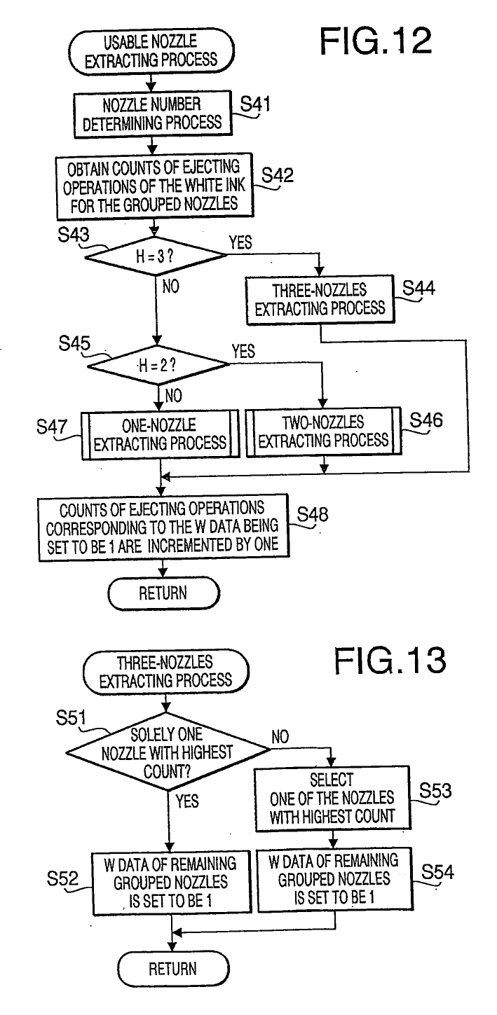

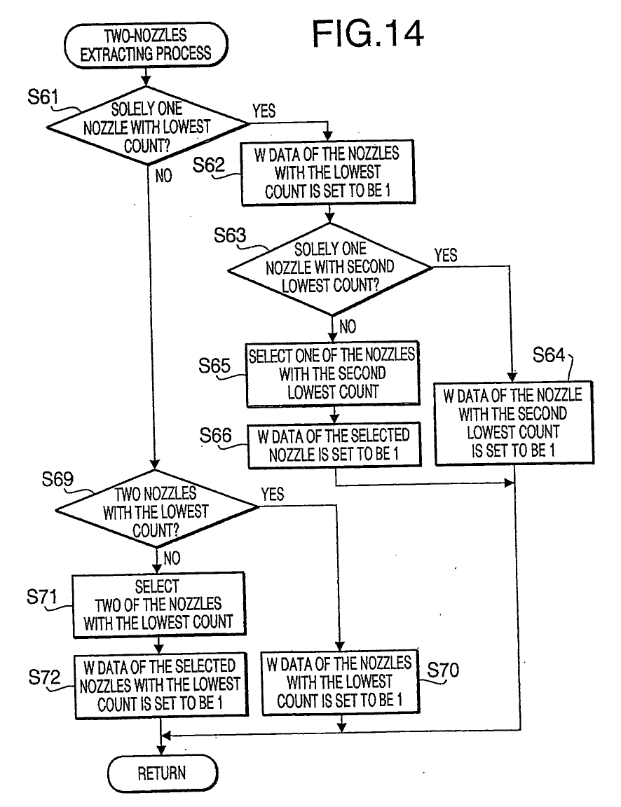

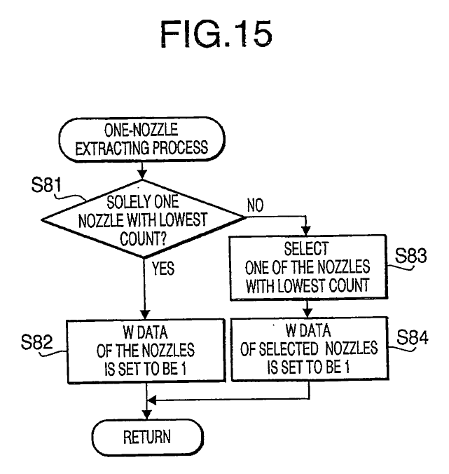

FIG. 10 is a flowchart to illustrate the print data generating process to be executed in the PC 100 according to the embodiment of the present invention. FIG. 11 is a flowchart to illustrate the W data calculating process to be executed in the print data generating process according to the embodiment of the present invention. FIG. 12 is a flowchart to illustrate an usable nozzle extracting process to be executed in the W data calculating process according to the embodiment of the present invention. FIG. 13 is a flowchart to illustrate a three-nozzles extracting process to be executed in the usable nozzle extracting process according to the embodiment of the present invention. FIG. 14 is a flowchart to illustrate a two-nozzles extracting process to be executed in the usable nozzle extracting process according to the embodiment of the present invention. FIG. 15 is a flowchart to illustrate a one-nozzle extracting process to be executed in the usable nozzle extracting process according to the embodiment of the present invention.

When the print data generating process starts, in S11, as shown in FIG. 10, the image data 141 to be printed in the image data storing area 1167 of the HDD 116 is read out to be set in the inputted image data storing area 1121 of the RAM 112, and a resolution R of the image to be printed, as specified by the user, is stored in the resolution storing area 1122.

In S12, the image data 141 in the inputted image data storing area 1121 is converted into CMYKW data 146 based on the color conversion table 161 and the white conversion table 162. Thereafter, in S13, the random-dithering process is applied to the CMYK values in the converted CMYKW data 146 to generate binary-formatted CMYK values. In S14, the binary-formatted CMYK values are stored in the print data storing area 1125 to be included in the print data 148. Thereafter, in S15, the random-dithering process is applied to the W data in the converted CMYKW data to generate quinary-formatted W data, and a number H of the usable nozzles among the four grouped nozzles is calculated for each pixel. The calculated numbers H are stored in the white nozzle usage storing area 1124 to be the white nozzle usage data 147. In S16, the W data calculating process is executed.

As shown in FIG. 11, when the W data calculating process starts, in S21, one of pixels which composes the image data 141 is targeted as a currently marked pixel. In S22, a number H of the usable nozzles for the marked pixel is read out from the white nozzle usage storing area 1124. Thereafter, in S25, it is examined as to whether the number H of the usable nozzles is 4. If the number H is 4 (S25: YES), the four grouped nozzles in the inkjet heads 11-14 will be activated to eject the white ink therefrom for the marked pixel. Therefore, in S26, a value “1” indicating activation of the nozzle is provided to each of the W1-W4 data for the marked pixel.

In S25, if the number H is not 4 (S25: NO), in S29, it is examined as to whether the number H is 0. If the number H is 0 (S29: YES), none of the four grouped nozzles will be activated. Therefore, in S30, a value “0” indicating that no nozzle will be activated is provided to each of the W1-W4 data for the marked pixel. In S29, if the number H is not zero (S29: NO), in S31, an usable nozzle extracting process will be executed.

In the W data calculating process, when all of the four grouped nozzles are to be activated to eject the white ink (S25: YES), and when none of the four grouped nozzles are to be activated (S29: YES), the currently marked pixel is eliminated from being processed in the usable nozzle extracting process (S31) in FIG. 12.

As shown in FIG. 12, when the usable nozzle extracting process starts, in S41, a nozzle number determining process is executed. In the nozzle numeral determining process, the grouped nozzles with an identical nozzle number to be activated to eject the white ink on the currently marked pixel are determined.

In the present embodiment, as has been described above, the information concerning the inkjet printer 1 is stored in the printer information storing area 1165 of the HDD 116. Specifically, the information concerning the number n of the nozzles aligned in line in each inkjet head (n=128), the length L between adjoining nozzles in the alignment in the inkjet head (L= 1/150 inch), the number of the inkjet heads 11-14 for the white ink (4) is recorded Based on the information and the resolution R stored in the resolution storing area 1122 of the RAM 112, behaviors of the platen 5, i.e., amounts of the platen 5 to be driven in the auxiliary direction upon line break of the carriages 10, 20, are determined.

For example, in the present embodiment, it is assumed that the user specifies the resolution to be 600 dpi (dot per inch). When the resolution is 600 dpi, X-Y coordinates with a basic unit being 1/600 inch are developed on the image data. According to the present embodiment, upon line break when the carriage is returned to a head of a line for a first time, the platen 5 is driven for 1/600 inch (i.e., a length corresponding to the basic unit of the coordinate) in the auxiliary direction. Further, the platen 5 is driven for 1/600 inch for a second return, and for 1/600 inch for a third return. When a printing operation for a fourth portion after the third return is completed, while 1/600 inch*4= 1/150 inch being the length L between the adjoining nozzles in each nozzle alignment, rendering of a length corresponding to 512 (i.e., 128*4) pixels in a direction of the Y coordinate completes. Therefore, upon a fourth return, a length of the platen 5 to be driven is 509/600 inch (i.e., 512/600 inches− 3/600 inches= 509/600 inches). The above behaviors of the platen 5, the carriages 10, 20 being a set are repeatedly performed in the printing operation.

According to the above behaviors, when the printing operation starts forming pixels, starting from a pixel with its Y-coordinate being 0, a pixel with its Y-coordinate being one of 0-3 is formed in the ink ejected from a rearmost nozzle with its nozzle number being 1. Further, a pixel with its Y-coordinate being one of 4-7 is formed in the ink ejected from a nozzle with its nozzle number being 2, and a pixel with its Y-coordinate being one of 508-511 is formed in the ink ejected from a nozzle with its nozzle number being 128. Similarly, in the second set of the behaviors, a pixel with its Y-coordinate being one of 512-515 is formed in the ink ejected from the nozzle with its nozzle number being 1, and a pixel with its Y-coordinate being one of 1020-1023 is formed in the ink ejected from the nozzle with its nozzle number being 128.

According to the above set of behaviors, the nozzle number of the nozzle to be activated is obtained by (y−A)/LR being divided by n plus 1, while y indicates a Y-coordinate of the pixel, and A indicates a remainder of y being divided by LR. For example, when the resolution R is 600 dpi L is 1/150, n is 128, and L*R is 600/150 being 4, the nozzle number is (y−A)/4 being divided by 128 plus 1. Thus, the nozzle number of the four grouped nozzles can be determined based on the distance of the platen 5 to be driven in the auxiliary direction, the number n of the nozzles in the nozzle alignments, the length L between the nozzles, and the resolution R.

After the nozzle numeral determining process in S41 in FIG. 12, in S42, the white nozzle usage storing area 1166 of the HDD 116 is referred to and counts of ejecting operations of the white ink for the grouped nozzles are obtained. More specifically, in the present embodiment, the nozzle number determined in the nozzle numeral determining process in S41 is expressed as “t,” and the count of ejecting operations in the inkjet head 11 is expressed as “K1_{—}t” Similarly, the counts of ejecting operations in the inkjet heads 12, 13, 14 are expressed respectively as “K2_{—}t,” “K3_{—}t,” and “K4_{—}t” Next, in S43, it is examined as to whether a number H of the usable nozzles for the currently marked pixel is 3. If the number H is 3 (S43: YES), in S44, a three-nozzles extracting process is performed.

When the three-nozzles extracting process starts, as shown in FIG. 13, in S51, the count of ejecting operations in the four grouped nozzles are compared, and it is examined as to whether there is one nozzle among the four grouped nozzles of which count of ejecting operations indicates a largest number. If there is one nozzle (S51: YES), in S52, the W data of the remaining grouped nozzles, other than the nozzle with the highest count of ejecting operations, is set to be 1, which indicates activation of the nozzles to eject the white ink. The process returns to the usable nozzle extracting process in FIG. 12 thereafter. In S51, if there are more than one nozzle with the highest count of ejecting operations (S51: NO), in S53, one of the grouped nozzles is selected to be unusable for the currently marked pixel. Selection of the unusable nozzle among the grouped nozzles with the highest count of ejecting operations can be selected, for example, according to a random number or a predetermined rule. The nozzle selected to be unusable becomes likely to be selected in a next usable nozzle extracting process; therefore, emphasized usage of specific nozzles can be avoided. Thereafter, in S54, the W data of the remaining grouped nozzles, other than the unusable nozzle, is set to be 1, which indicates activation of the nozzles. Thereafter, the process returns to the usable nozzle extracting process in FIG. 12.

In S43 in FIG. 12, if the number H of the usable nozzles for the currently marked pixel is not 3, in S45, it is examined as to whether the number H of the usable nozzles for the currently marked pixel is 2. If the number H is 2 (S45: YES), in S46, a two-nozzle extracting process is performed.

When the two-nozzles extracting process starts, as shown in FIG. 14, in S61, the count of ejecting operations in the four grouped nozzles are compared, and it is examined as to whether there is one nozzle among the four grouped nozzles of which count of ejecting operations indicates a smallest number. If there is one nozzle (S61: YES), in S62, the W data of the nozzle with the lowest count of ejecting operations is set to be 1, which indicates activation of the nozzle to eject the white ink. Thereafter, in S63, it is examined as to whether there is one nozzle among the four grouped nozzles of which count of ejecting operations indicates a second smallest number. If there is one nozzle with the second lowest count of ejecting operations (S63: YES), in S64, the W data for the nozzle with the second smallest number is set to be 1. The process returns to the usable nozzle extracting process thereafter. In S63, if there are more than one nozzle with the second lowest count of ejecting operations (S63: NO), one of the plurality of grouped nozzles is selected to be usable for the currently marked pixel. Selection of the usable nozzle among the plurality of grouped nozzles with the second lowest count of ejecting operations can be selected in any method, as well as the selection being made in S53. In S66, the W data of the selected nozzle is set to be 1, and the process returns to the usable nozzle extracting process thereafter.

In S61, if there is more than one nozzle with the lowest count of ejecting operations (S61: NO), in S69, it is examined as to whether there are two nozzles with the lowest count of ejecting operations. If there are two (S69: YES), in S70, the W data of the two nozzles with the smallest number of the ejecting operations is set to be 1. The process returns to the usable nozzle extracting process thereafter. In S69, if there are more than two nozzles with the lowest count of ejecting operations (S69: NO), in S71, two nozzles among the three or four grouped nozzles are selected to be usable. In S72, the W data of the selected nozzles is set to be 1, and the process returns to the usable nozzle extracting process thereafter.

In the usable nozzle extracting process, as shown in FIG. 12, if the number H of the usable nozzles for the currently marked pixel is neither 3 (S43: NO) nor 2 (S45: NO), i.e., 1, in S47, a one-nozzle extracting process is performed.

When the one-nozzle extracting process starts, as shown in FIG. 15, in S81, the count of ejecting operations in the four grouped nozzles are compared, and it is examined as to whether there is one nozzle among the four grouped nozzles of which count of ejecting operations indicates a smallest number. If there is one nozzle (S81: YES), in S82, the W data of the grouped nozzle with the lowest count of ejecting operations is set to be 1, which indicates activation of the nozzle to eject the white ink. The process returns to the usable nozzle extracting process in FIG. 12 thereafter. In S81, if there are more than one nozzle with the lowest count of ejecting operations (S81: NO), in S83, one of the grouped nozzles is selected to be usable for the currently marked pixel. Thereafter, in S84, the W data of the selected nozzle is set to be 1. Thereafter, the process returns to the usable nozzle extracting process in FIG. 12.

In the usable nozzle extracting process, following one of S44, S46, and S47, in S48, the counts of ejecting operations corresponding to the W data being set to be 1 are incremented by one. The process returns to W data calculating process in FIG. 11 and proceeds to S33. In S33, it is judged as to whether the W data calculating process is applied to all the pixels included in the image data 141. If a pixel remains unprocessed (S33: NO), the process returns to S21, and a next pixel is targeted as a marked pixel. If all the pixels are processed (S33: YES), the process returns to the print data generating process in FIG. 10. The process is terminated thereafter.

As has been described above, according to the PC 100 in the present embodiment, a number H of the usable nozzles for a pixel among the four grouped nozzles in each of the inkjet heads 11-14 is calculated for each pixel. Based on the calculation, a nozzle with a smallest number of usage is preferentially extracted to be usable, so that the print data 148, in which the least used nozzle among the four grouped nozzles can be used to eject the white ink, is generated. Thus, the plurality of substantially equivalently functioning nozzles can be evenly used, and it can avoid the nozzles from being dried and coagulated. Therefore, the quality of the printed image can be maintained without being affected by the emphasized usage of the nozzles.

Further, the random-dithering process to convert the W data in the Converted CMYKW data 146 into the quinary-formatted values, the number of usable nozzles can be obtained. Therefore, errors in the converted CMYKW data 146 can be dithered to surrounding pixels so that the print data to print an image in a better quality, better than the print data generated in another method such as a threshold method, can be generated. Furthermore, due to the print data 148 being the binary-formatted data, the amount of the inks (i.e., the size of the ink drops) being ejected can be stabilized to print the image, and the inkjet printer 1 can be controlled easily.

Further, it is to be noted, when all of the four grouped nozzles are to be activated to eject the white ink (S25: YES), and when none of the four grouped nozzles are to be activated (S29: YES), the currently marked pixel is prevented from being processed in the usable nozzle extracting process (S31) in FIG. 12; therefore, unnecessary processes can be omitted, and the print data 148 can be generated in shorter time. Moreover, according to the print data 148 in the above embodiment, in which a larger amount of white ink than the other colored inks is consumed, the inkjet heads 11-14 for the white ink can be prevented from being dried.

Although an example of carrying out the invention has been described, those skilled in the art will appreciate that there are numerous variations and permutations of the print data generating apparatus that fall within the spirit and scope of the invention as set forth in the appended claims. It is to be understood that the subject matter defined in the appended claims is not necessarily limited to the specific features or act described above. Rather, the specific features and acts described above are disclosed as example forms of implementing the claims.

For example, the method to obtain the white nozzle usage data 147 is not limited to the random-dithering method to convert the W data in the converted CMYKW data 146 into the quinary-formatted data For example, the white nozzle usage data 147 may be obtained in a threshold method with four thresholds to sort the W data into one of five scales according to the four thresholds.

For another example, a different method to count the counts of ejecting operations of the nozzles may be employed. According to the present invention, the counts of ejecting operations are counted in order to avoid emphasized usage of specific nozzles; therefore, in the above embodiment, when all of the four grouped nozzles are activated (S25: YES), the ejecting operation is not counted. However, the ejecting operations in the four grouped nozzles may be equally counted.

Further, the nozzle numeral determining process (S41 in FIG. 12) may be arbitrarily modified. In the above embodiment, the nozzle numbers of the usable nozzles to eject the white ink to form a pixel are determined based on the distance of the platen 5 to be driven in the auxiliary direction upon line feed, the Y-coordinate y of the marked pixel, the number n of the nozzles aligned in line in each inkjet head, the length L between adjoining nozzles in the alignment, and the resolution R. However, a table to define correspondences between the Y-coordinates and the nozzle numbers can be preliminarily stored in, for example, the HDD 116 so that the nozzle numbers of the usable nozzles can be obtained with reference to the table. Various patterns of the table can be prepared preliminarily to define correspondences of the above factors. Thus, the nozzle numbers of the usable nozzles can be determined promptly.

Furthermore, the data formats to be used in the PC 100 are not limited to sRGB format or CMYKW format In the above embodiment, the image data 141 in sRGB format is converted into the CMYKW data 146 in 256-scaled format, and thereafter into the print data 148 in the binary format. However, the image data 141 may be represented in CMYK format or a data format to represent another color space such as HSV format. The color conversion table 161 and the white conversion table 162 can be replaced with another tables to define the correspondences between one data format and the other data format accordingly. Further, the data format of the print data 148 can be replaced with a data format other than CMYKW format, and the scale of the color data is not limited to 256.

Furthermore, the configuration of the inkjet printer 1 is not limited. For example, in the above embodiment, the print data 148 for the inkjet printer 1 equipped with the four inkjet heads for the white ink is generated. However, the present invention can be applied to an inkjet printer with a plurality of inkjet heads for ejecting ink in a specific color. When a number of the inkjet heads for white ink is N, the W data in 256 scales in the converted CMYKW data 146 can be converted into N+1 scales in a random-dithering method. The present invention can be also applied to an inkjet printer having a plurality of inkjet heads which are to eject ink in a specific color other than white. Furthermore, the present invention can be applied to an inkjet printer having a single carriage with eight inkjet heads, four of which are to eject the white ink, and the remaining four of which are to eject C, M, Y, K inks respectively.

What is claimed is:

1. A print data generating apparatus to generate print data, which is to be used in a printing apparatus, capable of ejecting a plurality of ink drops of ink in a same specific color on a same spot to form a pixel, to print an image based on originally inputted image data representing the image, comprising:
a plurality of inkjet heads, each of which is provided with a plurality of nozzles aligned in line to eject the ink,
a usable nozzle number determining unit to determine a number of at least one usable nozzle to be used to form the pixel among a group of nozzles, which are provided to corresponding positions in the respective inkjet heads and potentially capable of ejecting the ink on the same spot, for each pixel included in the image data;
a count storing unit to store a count of ejecting operations of each nozzle to be performed for printing the image;
a usable nozzle extracting unit to extract the at least one usable nozzle among the grouped nozzles based on the counts of ejecting operations of each nozzle stored in the count storing unit; and
a print data generating unit to generate the print data, which controls the at least one usable nozzle, extracted by the usable nozzle extracting unit, to eject the ink to form the pixel,
wherein the usable nozzle extracting unit extracts at least one nozzle with a lower count of ejecting operations preferentially to be the at least one usable nozzle among the grouped nozzles based on the number determined by the usable nozzle number determining unit.

2. The print data generating apparatus according to claim 2,
wherein the usable nozzle number determining unit determines the number of at least one usable nozzle for each pixel by processing scale values of the specific color of the ink in the image data in a random-dithering method to dither into multiple values.

3. The print data generating apparatus according to claim 1, wherein the print data to be generated is binary-formatted data to control activation and inactivation of the plurality of nozzles for ejecting the ink.

4. The print data generating apparatus according to claim 1, further comprising a nozzle numeral determining unit to determine the group of nozzles being potentially capable of ejecting the ink on the same spot based on a number of the nozzles aligned in line in each inkjet head, a length between adjoining nozzles in the alignment, and a resolution of the image.

5. The print data generating apparatus according to claim 1, comprising an eliminating unit to eliminate the pixel from being processed by the usable nozzle extracting unit when the number of at least one usable nozzle determined by the usable nozzle number determining unit corresponds to a number of the inkjet heads having the nozzle alignments.

6. The print data generating apparatus according to claim 1, comprising an eliminating unit to eliminate the pixel from being processed by the usable nozzle extracting unit when the number of at least one usable nozzle determined by the usable nozzle number determining unit is zero.

7. The print data generating apparatus according to claim 1, wherein the specific color of the ink is white.

8. A method to generate print data to control a printing apparatus, which is capable of ejecting a plurality of ink drops of ink in a same specific color on a same spot to form a pixel and having a plurality of inkjet heads, each of which is provided with a plurality of nozzles aligned in line to eject the ink, based on originally inputted image data representing the image, comprising steps of:
determining a number of at least one usable nozzle to be used to form the pixel among a group of nozzles, which are provided to corresponding positions in the respective inkjet heads and potentially capable of ejecting the ink on the same spot, for each pixel included in the image data;
storing a count of ejecting operations of each nozzle to be performed for printing the image;
extracting the at least one usable nozzle among the grouped nozzles based on the counts of ejecting operations of each nozzle stored in the count storing unit; and
generating the print data, which controls the at least one usable nozzle, extracted by the usable nozzle extracting unit, to eject the ink to form the pixel,
wherein at least one nozzle with a lower count of ejecting operations is extracted preferentially to be the at least one usable nozzle among the grouped nozzles in the step of extracting based on the number determined in the step of determining.

9. A computer usable medium to comprise computer readable instructions to control a computer to generate print data, which is to be used in a printing apparatus capable of ejecting a plurality of ink drops of ink in a same specific color on a same spot to form a pixel and having a plurality of inkjet heads, each of which is provided with a plurality of nozzles aligned in line to eject the ink, based on originally inputted image data representing the image, comprising steps of:
determining a number of at least one usable nozzle to be used to form the pixel among a group of nozzles, which are provided to corresponding positions in the respective inkjet heads and potentially capable of ejecting the ink on the same spot, for each pixel included in the image data;
storing a count of ejecting operations of each nozzle to be performed for printing the image;
extracting the at least one usable nozzle among the grouped nozzles based on the counts of ejecting operations of each nozzle stored in the count storing unit; and
generating the print data, which controls the at least one usable nozzle, extracted by the usable nozzle extracting unit, to eject the ink to form the pixel,
wherein at least one nozzle with a lower count of ejecting operations is extracted preferentially to be the at least one usable nozzle among the grouped nozzles in the step of extracting based on the number determined in the step of determining.
